(19) United States
(12) Patent Application Publication
(10) Pub. No.: US 2009/0150193 A1
(43) Pub. Date: Jun. 11, 2009

(54) Comprehensive Integrated Online Order and Reservation Platform with Instant Notifications and Interactive Communications

(76) Inventors: Jin Hong, Saratoga, CA (US); Qihong Nicki Zhang, Saratoga, CA (US)

Correspondence Address: Jin Hong, 19796 Bonnie Ridge Way, Saratoga, CA, 95070, US

(21) Appl. No.: 12/202,225

(22) Filed: Aug. 30, 2008

Related U.S. Application Data
(60) Provisional application No. 60/969,697, filed on Sep. 4, 2007.

(51) Int. Cl. G06Q 10/00; G06Q 30/00

(52) U.S. Cl. 705/5; 705/26

(57) ABSTRACT

An fully integrated online ordering, online reservation and online catering platform, an advanced software system architecture, and a suite of new types of online services designed and suitable for various industries, especially for restaurant industry, providing business owners and Internet users with a comprehensive and reconfigurable sets of options to deliver and respond to online requests automatically and instantly through various means of real time interactive communications.

This U.S. Patent Application is the official continuation filing of the previously filed provisional U.S. Patent Application No. 60/969,697, filed on Sep. 4, 2007, entitled “Comprehensive Integrated Online Order and Reservation Platform with Instant Notifications and Interactive Communications”, and incorporated herein by reference.

### BACKGROUND OF THE INVENTION

1. Field of the Invention

The present invention is generally related to a comprehensive, unique, and novel Internet based online order and online reservation system, and more particularly to the system architecture that can automatically transmit the online order and reservation request from the end consumers to the associated business owners, via various means individually or simultaneously such as the use of Internet, the mobile devices with instant messaging, the landline phones, the fax machine, and the network attached printers. The present invention is also related to a comprehensive set of new architectures and online service features that have never been proposed, developed, and put into service in the past in the Internet service industry. These key features include but are not limited to the following:
1) Easy to use intuitive online ordering system utilizing the novel “ordering sheet” concept and architecture to greatly help to facilitate the ordering process, much more intuitive and convenient to use in comparison with the use of so called “shopping cart”. With the ordering sheet side by side shown to the consumers on only portion of the current screen and is persistently present and constantly updated during the back and forth ordering process from page to page, this new persistent ordering sheet concept and the service offered is highly demanded by end consumers. It provides a very clear and intuitive solution to the otherwise complex and less user friendly online ordering process using shopping cart.
2) Online ordering and online reservation services are seamlessly integrated in the same platform to provide users the options and abilities to handle both online ordering and online reservation at the same time, providing much better user experience in comparison with any other service that is focused only on either one of them. This platform provides one stop solution to both end users and business owners.
3) Online ordering can be made with the distinction of either for taking out only or for delivery service by the business owners, providing both the business owners and the end consumers the options to address their own needs effectively and efficiently.
4) Online coupon is made available not only for viewing by the end consumers, but also for placing real online ordering directly for items contained inside the coupon. In other words, the end consumer can make online ordering not only for the regular items, but also for the special items listed in the coupon directly, combined with the regular online ordering. This eliminates the need for the end consumers to bring the hard copy of coupon to the business owners to show the proof of the coupon. The individual items or the conditions of the coupon can now be directly applied to the online order request and will be sent over to the business owners instantly.
5) Online catering is proposed and implemented by our innovative solution for the first time in the Internet online service business. Normally, the catering service is tedious, time consuming, and error prone, sometimes even quite painful to business owners. This online service solution maximizes the benefits of Internet and online service, and addresses the very problem occurred in the restaurant industry for many years. This online catering service solution now can provide the real time online tracking and editing platform so that both the end consumers and the business owners can easily review, select, and modify their options for the catering services. The business owners can change the service options and price at any time. The end users can pick whatever they like and request the business owners for special services to meet their needs. It is an automatic process that can be tracked.
6) Online reservation with advanced ordering is another feature that is very innovative in this platform. It provides the customers the ability to make online reservation first and at the same time, to place advanced order for the party or for each guest along with the reservation to minimize the waiting time at their arrival.

2. Description of the Prior Art

Online services such as online ordering or online reservations have become increasingly the choice of consumers, due to the fast penetration of Internet and the wide spread availability of high speed broadband wireline and wireless connectivity to the home, business, school, government agencies and public places.

Internet service has since gone through a profound change after the emergence of Internet itself in the past two decades. There are several types of online service platforms that exist today and address a variety of applications. Each type has its own unique characteristics and is designed for different applications.

For example, now it is common for ordinary people to place online order for books, cloths, consumer electronics and other durable goods using online ordering system offered by various Internet portals such as amazon.com, ebay.com, and by various merchants' own online portals such as fryselectronics.com, sears.com, walmart.com, and etc.

The common portion of these online portals is that they sell durable goods online. The end consumer places their online order from these web sites by utilizing their own credit cards or membership account login information. Once the order is placed online, the corresponding merchant will take the payment first, either through credit card, or other payment methods, and then ship the ordered items to the consumers in some time ranging from few days to few weeks.

Similarly online reservation can also be made for hotel rooms, air tickets, and rental cars, pretty much in the same way as for the ordering of durable goods by using credit card or membership account login information. Consumers can go to different specialized online portals such as expedia.com, travelocity.com, priceline.com, orbitz.com, hotwire.com, or from the online portal sites from the business identities directly, such as from ua.com, aa.com, hilton.com, and etc. If there is any difference between these types of business portals with the portals for durable goods' online ordering, then it will be the option to have an electronic ticket or confirmation instead the paper ticket or paper confirmation, so that it is much more efficient and effective when planning online reservations for the air tickets, hotels and rental cars.

All of these online order or online reservation businesses are related to the durable goods or the travel/vacation/entertainment arrangement. Since these activities are involved a lot of time, money and commitment, and therefore normally are planned well ahead of time, and not so time critical at the time of ordering or reservation. In addition, all of these activities require the advanced payment first, before anything can be confirmed or shipped. So there is little risk for the merchant in terms of payment.

However, there are some other industries which really need the Internet online services as well, such as the restaurant industry. It is a vast consumer market that is keeping growing very fast due to the growth of economy and the growth of Internet, and due to the fact it is part of people's daily life and cannot do away with it easily.

Based on American Restaurant Association Report (please check out the report at http://www.restaurant.org/research/ind_glance.cfm), in 2002, Americans spent $373 billions of dollars in the restaurants, with $2137 spent per household, which represents 41% of household annual food budget. For age group between 45 to 54 years old, about $2638 average expenditure per household were spent. For people who are 25 years or younger, 49% annual food budget were spent in the restaurants. In 2006 forecast, the spending in restaurants had a 5.1% increase over 2005, representing 4% of US gross domestic product, and the restaurant industry represents 9% of total people employed in US. There were $511 billions of total sales in 2006, among them $468 billions of dollars were from commercial sales at eating and drinking places such as restaurants and etc (excluding lodging place restaurants and vending machine, and etc). In America, there are about 925,000 restaurants, eating & drinking places serving the food, with $1.6 billions of dollars sales on a typical day in 2006. There are 12.5 millions of employees, working in the restaurant industry and its industry economic impact exceeded $1.3 trillions of dollars. For each of the full service restaurants, the average sales were at $755,000 per unit in 2006, and for limited service restaurants, the average was at $606,000. In addition, each household spent average $2434 for food while away from home, which was $974 per person in average. Also, 7 out of 10 or more drinking and eating places are independent operations, and normally with less than 20 employees. They form the very foundation of American restaurant business, which have been largely ignored so far by the Internet online service industry, due to their small size and diversity which are difficult to serve by the Internet companies.

On the other hands, the use of Internet in restaurant related business is keeping increasing over the last few years. For example, based on the American restaurant association's survey, in 2006, 31 percent of consumers used Internet to view a restaurant's menu, up from 12% in 2000, which was 30% of median size table service restaurant sales accounted for by travelers and visitors (therefore online reservation & search is critical). 44% of table service restaurant operators anticipate that takeout food order will represent a larger proportion of their total sales in 2006 (therefore online ordering is getting more and more popular and critical). Two out of three consumers agree that their favorite restaurant foods provide flavor and taste sensations that cannot be easily duplicated in their home kitchen (therefore online service is an ongoing and repetitively growing service). 48% of table service restaurant operators offering gifts or discounts anticipate these will represent a larger proportion of their total sales in 2006 (therefore online Ads, Web coupons, gift service are popular & critical).

There are already some Internet service companies who are working on addressing some of the restaurants industry now from several years ago. Each focuses on different aspect of the restaurant business and addresses them also from different angles.

For example, in the case of online reservation, when people make the reservation to the restaurants in advance, the time is not so critical. It can be made long time ahead or just in few hours or even half hour before hand. Secondly, the consumer does not have to make any advanced payment for the restaurant reservation, and the number of people is also a rough estimate only and can change anytime. In addition, this type of reservation can be cancelled anytime, and even without the cancellation, the party may not come at all without any penalty.

There are companies which are offering such online reservation services to the restaurants already. However, for example, some of these types systems are based on a distributed solution to the restaurants and require special computer and software on the restaurant side in order to support the reservation. They require the business owners (in this case the restaurants) to install a dedicated Internet connection, and a dedicated specially designed computer with touch screen functions, and also a special software developed for the local restaurants. With the installation of these hardware and software all specifically designed for the restaurants, a dedicate restaurant personnel also needs to be fully trained and present all the time in order to support the system and respond back to customers. This may be good for a very large and expensive restaurant or restaurant chain where such an extra expense or manpower can still be absorbed. For millions of mid size or small size restaurants owned by individual businessman or by family members, it is not cost effective and therefore not a good fit most of time to meet their daily need and budget.

In addition, they offer no online ordering capability to the end consumers, which is a big deal to many end consumers and also many business owners.

One of the reasons is that consumers like to go to the restaurants sometime through reservation, but sometime to take out the food, or order the food to be delivered to the local business address or even to their home directly.

The other reason is that some business owners would like to offer not only the online reservation service, but also the online order service to the community for people to take out the food themselves or for the business owners to deliver the food to the nearby businesses or homes.

The business owners like the idea to be able to attract new customers and to retain loyal customers through the offering of online services. That is why they need to have a single integrated online service platform and web portal that can offer all the service at once cost effectively, such as web site design, hosting, update, online ordering, online reservation, online coupon, online catering, and etc.

In addition, the end consumers who have enjoyed the convenience of online service demand even more in the online service. For example, some advanced consumers like to not only make online reservation to a specific restaurant, but also like to place advanced orders to the dishes they would like to enjoy when they come to the restaurants so they do not have to wait for too long for their favorite dishes to come, especially for a large party at a holiday time. They really like to be able to place both online reservation and online ordering at the same time to make their party event hassle free and much more enjoyable.

None of the current online reservation web sites can offer anything that is close to what has been described above and what have been requested by both business owners and end consumers. None can offer such a comprehensive one-stop-shop solution to the local business owners.

Our unique architecture and many of our innovative concepts, solutions, implementations and the service offering address exactly what are needed by the local business owners as well as the end consumers. Many of our service offerings and the unique innovations are first of its kinds in the industry and have never been addressed before by any of the existing services or existing web sites in the industry.

Another example is for online order made to the restaurants. There are several ways to address this application as well that exist today. For example, when end consumers place their online order request from the Internet, the request can be received by one central office where all of these requests can be reviewed in time, then separately handled by the office people. They can then either call the related restaurants to ask for the service on behave of the end consumers, or send a fax to the restaurant themselves to notify the restaurants of the end consumers' request without indicating which consumer is actually making the request. The central office becomes the processing center that acts as an intermediary linking the end consumers and the business owners, without business owners' knowing who is making the initial request. Then the central office also acts as the delivery agency to pick up the food from the restaurants and then deliver to the end consumers. This business model is based on the delivery of food to the end consumers by the Internet service company themselves, or through its arrangement with other delivery service companies. In addition to this model, some web sites offer online ordering service that allows the business owners such as the restaurants themselves to do the delivery of the food to the end customers, in conjunction with the delivery service by the online order service companies themselves. Some other examples that are doing the similar business but exclusively focusing on corporate orders and also have some credit and billing handling capability to facilitate the processing of the bills or reimbursement to the end consumers through the agreement with the corporate users. They are several other web sites that are offering online order as well, each with a bit of difference in their service areas, specialty, and focus. Nevertheless, they are in common in the way that they are only focused on online order and mostly serve as the intermediary between the business owners and the end consumers.

None of them have offered both online reservation and online ordering in the same platform, and none of them offer anything close to what our new platform have proposed, implemented, and offered to the business owners and to the end consumers.

For example, so far, almost none of Internet service companies mentioned above send the requests from the end consumers directly and instantly to the corresponding business owners. None of them have utilized the new technologies such as the instant messaging through mobile phones to notify the business owners. None of them even send the request directly to the fax machine of the related business identities without serving as the “middleman” in between. The business owners do not have the access to many of their customer information and database, so they cannot use the information themselves as the powerful tool for their own marketing purpose to enhance their own business. They are not at the control of their customers' information. They do not have the complete and real time access to their customer database, to their customers' past and current requests, their favorite dishes and timelines, and etc. Our new architectures and solutions address not only exactly these issues and but also much more beyond these.

Also, to the best of our knowledge, almost no companies has so far allowed the online orders of individual coupons or online orders of regular items in combinations with the associated coupons directly from online service portal without the need to either print out the coupons from the web sites in order to bring it to the business owners, or get some special codes for the coupons in order to prove to the business owners that a coupon is been used in conjunction with the regular order from online service sites.

In addition, no companies have offered the direct online transacted catering service so far, which is very challenging not only to the Internet service companies and the business owners, but also to the end consumers. The key issue is that from the Internet service business community, nobody has even recognized the tremendous amount of values this service has to the business owners and to the end consumers. We are the first to recognize the huge demands from the business owners and the end consumers in the restaurant industry.

On one hand, it is normally a very time consuming, tedious, and yet error prone process that most of the business owners and end consumers have to live it through each time they need it. On the other hand, it is a very complex technology issue that requires tremendous amount of advanced innovative architectural design, flexible and versatile handling of various catering needs. Each restaurant offers a complete different set of catering menus and different pricing structures, which is very difficult to handle by Internet, with the capability for both the business owners and the end consumers to have the ability to add, delete, revise, and modify the needs and the conditions of service offers.

Our innovative solution from www.YummyOrder.com addresses exactly the issue raised above for the online catering service. Our solution shall be able to the meet the diverse needs from both the business owners and the end consumers for their catering needs, with all the flexibility and easy to use features to accommodate their busy life style while making the online catering service an enjoyable and memorable experience for them every time they use it.

### SUMMARY AND DESCRIPTION OF THE INVENTION

The present invention is a comprehensive suite of innovative and unique business, technology and service offerings, as well as the related architectural designs and the detailed platform implementations to support these online services offered to the business owners and the end consumers alike, to make the online order and online reservation a totally new, enjoyable, memorable and very useful daily experience for millions of Internet users and business owners, in particular, in the restaurants industry.

Briefly, a preferred embodiment of the present invention includes a fully integrated online order and online reservation platform for the restaurant business, with the following key distinct features (not inclusive, and not limited to these mentioned here):
1) An aggregation web portal that targets the restaurants and Pizza stores around the globe, with automatic categories that automatically distinguish and list the restaurants with respect to the country, province/state, city, region, zip code, cuisine type, offered online service (such as online order, online reservation, online catering, online coupon, self take out, store delivery), and etc. It can also be ranked and rearranged its appearance by the order of cuisine types, English letters, or the city names, or based on the calculated distance near the customers.
2) An aggregation web portal that supports a detailed search engine of its own for search of items (in case of restaurants, the dish names and etc) and comparison of prices offered by different businesses at the same or different locations. It loads the menu in a centralized database and therefore each menu items and their characteristics and prices are all searchable and can be compared with the built in search engine.
3) An aggregation web portal that supports the online blogging and comments by the end consumers and the feedback/corresponding responses from the business owners, but monitored and mediated by the online service operator. In this way, a simple, fair, and interactive platform and environment is established for both the customers and the business owners to have their voice heard timely, openly, and fairly.
4) An aggregation web portal that supports a fully integrated and consistent online service platform which allows at least one of the following, or all of the following, or a selection of the following key services for each of the business owners (the service listed below is not exclusive and therefore is not limited to these):
   a. online ordering (either self take out service or delivery service)
   b. online ordering combined with discount or coupon
   c. online order directly only using coupon
   d. interactive online catering allowing multiple iterations between the end consumer and the business owners to reach their agreement on the catering service and payment terms
   e. group based online order allowing corporate or group members to order food online with their own choice from each of the members in the same group but is treated as a single order from business owners' perspective
   f. online reservation
   g. online reservation with advanced order from the menu for the party
   h. online ordering menu with dual language support
   i. online ordering menu with individual input notes and labels
   j. online service that allows for the self editing and self loading of the online ordering menus so that the business owners can regularly update their online order information on the web sites themselves easily and intuitively.
5) An aggregation web portal that offers a secure and centralized database system which allows both the end consumers and the business owners to track all the current and past online orders and reservations record with all the details anytime anywhere, and from any computer or Internet enabling devices, whether at home, from work, or on the road. Both the end consumers and the business owners are at the full control of their own information, and the information about the customers' favorite restaurants or favorite dishes, or the business owners' new or loyal customers as well as their contacts and likings.
6) An aggregation web portal that offers the real time interaction between the end users and business owners once the online order or online reservation has been made. The business owners can notify the end customers in real time about the receiving of the request, and the status of the request, such as whether the request has been received, processed, rejected, to be modified, or honored, fulfilled, and etc. The end consumers can be notified instantly each time the status has been changed through various means, such as Internet, emails, instant message, or mobile phones.
7) An aggregation web portal that offers the instant delivery of end consumers' online order or online reservation request to the corresponding business owners through a variety of communication means, using either one of them, all of them, or a combination of them pending on the need and the choice of the business owners.
8) Instant notifications of online request using mobile phones with instant message:
   One of the means used above to deliver the request instantly to the business owners is the use of wireless or mobile devices, such as the cell phones, smart phones, PDA devices, BlackBerry devices, and etc.
   The online request will be automatically transmit to the business owners through the use of instant message and ring tones on the cell phones. The business owners can assign either one or more mobile phones to be notified of the arrival of the request and the instant message will carry the details of the online order or online reservation. All mobile phones will be notified instantly at the same time with the same instant message, so that not only the business owners, but also the restaurant floor managers and their key personnel can receive the same online request at the same time, so they will not miss any urgent online request for any reasons.
   This is a unique feature for our system. This feature offers the instant notifications to the business owners on the go all the time, so that they will not miss any single online order or online reservation at any time, even if it is not in business hours and the restaurants may be closed at the time of online request for any particular reasons. The business owner can still respond to the online request anytime when he/she receives the online request and can decide when and how to respond back to the customers.
   There are many ways to do so with our solutions. He/she can call back right away since the information is on his mobile phone anyway, or he/she can choose to respond using the Internet features built into our system to respond to the customer with a single click, or with his own comments. The Internet feature is supported by our system and will be described in the few items below.
9) Deliver online request instantly using fax message
   One of the means used above to deliver the request instantly to the business owners is to send the online request directly and automatically to the fax machine in the restaurant through the Internet without any involvement of the Internet service company. There is no manual intervention in between, and no one will be the intermediary between the end consumer and the business owner. The transmission of fax is immediate and no delay of processing of the online request. In this case, the restaurant floor managers or any of their employees can receive the online request and handle it on time without any delay or confusion as to what has been requested by the customers.
   In this case, the restaurants can choose various ways to respond to the customers, either through phones, or Internet features from our system, or do nothing except to prepare for the request, pending on the information on the online request faxed over.
   If it is an online order either for taking out or for delivery, the restaurant can simply prepare for the food first. If it is an online reservation, the restaurant can choose to respond using our Internet feature in one or two clicks or choose to call back the customer for confirmation. In essence, it offers the restaurant owners multiple choice pending on which one is best suitable to the situation.
   Our system is flexible and versatile, and can simultaneously send information to the business owner in multiple ways so they can decide on how to handle the online request accordingly in each case.
10) Deliver the online request using network attached printers
   One of the means used above to deliver the request instantly to the business owners is to send the online request directly and automatically to the printer machine attached either directly or through wireless to the computer that is connected to the Internet in the restaurant without any direct manual involvement. The other way is to send the message to the network attached printers without the need for computers. This type of networking attached printers is a powerful tool for sending the message over to the restaurants directly and instantly. The small size of the printers and the printing paper/label is ideal for the restaurant business. Some of the printers such as the POS printers can even print directly to the label that can be used to stick either to the book-keeping record or to the delivery items for the customers.
   The use of printers eliminates the need for dedicate phone line for fax, since the printers are usually attached to the computers and therefore share the Internet connection which is usually there already for most of the business owners due to the fast penetration of broadband Internet connections into small business and home business (SOHO), not to say the middle sized or large sized business. It is also more cost effective to have the printers to print out the online orders or reservations, so that the business owners can use them as the stickers for the corresponding orders or as the note for the reservations. It can be used conveniently for the customer ordered food labeling or delivering services, or combined with the regular book keeping practice in the reservation book.
11) Deliver online request using email
   One of the means used above to deliver the request instantly to the business owners is to send the online request directly and automatically to the business owners' email address. So the owners can have the access to the emails anywhere anytime and from any computer. The owners can also respond back to the customers directly using emails. This gives the owners the convenience to communicate to the customers, especially the business customers easily. The email notification is only one of the complementary means and is not meant to be the most important and dominant way to send the online request to the business owners. It is not necessary to be used but normally business owners like to have the options and are willing to receive the emails as well on top of all other major options.
12) Deliver the online request instantly using registered Internet account
   One of the means used above to deliver the online request instantly to the business owners is to send the online request through Internet directly and automatically. Since our innovative architecture is based on the centralized server system, the business owners do not need any special Internet devices, do not need any special computer hardware, and do not need any special computer software either.
   They can use any computers from anywhere at any time to access their Internet account through Internet. They can review any one of the current online requests and all of the past online requests. They can respond to the online order or online reservation in real time to the customers directly in their account by simply clicking on few ready to use buttons, such as acknowledging the receipt of the online request, updating the online request status, honoring the request, fulfilling the request, in order to make the status known to the customers.
   There are many different statuses that the owner can choose from for either online order or online reservation. Some of the statuses can be one of the following (but not limited to): “received”, “confirmed”, “rejected”, “fulfilled”, “to be further determined”, “no show”, “show up”, “show up with less people as requested”, “food taken”, “food delivered”, and etc. The end consumers can review the statuses online as well anytime, anywhere, and from any computer connected to the Internet.
   On one hand, the business owners will be able to review and respond to all the online order and reservation requests from all the customers who have made requests to their restaurants. In this way, the owner can have a rich database of his/her customers, the customers' contact information, locations, favorite dishes, time of the parties, and etc.
   On the other hand, the end consumer can review all the online orders and reservations he/she has made so far to all the restaurants up to now, and with all the information about the restaurants' information, his/her favorite dishes, and the time and size of the past parties and etc. The consumer can recommend to his/her friends/family members/co-workers and etc the restaurants and the dishes he/she really likes.
13) Instant and simultaneous delivery of online request
   The key part of the instant notification to the business owners without the intermediary manual intervention is the use of a combination of some of the means mentioned above simultaneously.
   For example, the most popular choice from many business owners is the use of most of the above means at the same time: The online request will be sent to several mobile phones through instant message (owner's cell phone, floor manager's cell phone, the waitress's cell phone) automatically from the aggregation web site or our customers' own website once the online order or reservation request has been submitted by the end consumer.
   It will also be sent to either the fax machine located at the front desk of the restaurants or the printer attached with the computer at the front desk (if it is the network attached standalone printer, it is even better).
   Of course, at the same time, it will always be sent to the owners' email, and to the owner's Internet account registered with our aggregation service web site (such as on www.YummyOrder.com).
   So the business would know instantly that an online request has come due to the cell phone rings associated with the arrival of instant message. Or they will know instantly that the online request has come out of the fax machine or out of the printer indicating the arrival of online request. They can choose how to respond to the customers based on the nature of the online requests (ordering, reservation, catering and etc) by either using cell phone calls, sending response email, or login into their Internet account to respond directly, or simply do not respond if there is no need, and then either directly deliver the food to customers, or wait for the customers to come over for pick up, or prepare for the customers to come to have the party, and etc.
14) “Online ordering sheet” for convenience
   One of the other most important features of our solutions is the innovative and intuitive “online ordering sheet” feature implemented on our web site. The feature addresses a fundament issue in most of the online service business that is related to the use of “shopping cart”.
   The “shopping cart” is a modular software package embodied in several different ways and developed by many Internet service companies to help online commerce companies to facilitate the online shopping, in the way very similar to the real shopping cart used in the shopping mall in people's daily life.
   The online customers will pick any items they would like to have and then place them into the online “shopping cart” and then move on to the different places or pages on the online commerce's web site while they continue to shop for what they need from pages to pages, from categories to categories, from areas to areas.
   Each time when the new item is placed inside the “shopping cart”, it is hidden inside the cart and cannot be viewed directly unless the customers specifically open the “shopping cart” again to review all the items already inside the cart.
   This is very inconvenient for customers, especially when they try to go back and forth to check the items again and again to make sure they do not miss or over order anything. The web site will not be able to remember which one has been ordered and placed inside the cart and which one has not been ordered at all. The customers have to review the items inside the cart every time he/she wants to see what is inside and how much has already been ordered, or when he/she comes back to the same page or category for shopping again and cannot remember whether he/she has ordered certain items.
   For online order to the restaurants, this would be a very tedious and boring task to go back and forth to check which dishes have been ordered and how many dishes have been selected, since they have to order different dishes for the request.
   In order to overcome the limitation and inconvenience of “shopping cart”, a very innovative and intuitive approach and solution to the online ordering process has been proposed and implemented. This is the “online ordering sheet” solution.
   In this solution, an “online ordering sheet” is created automatically, similar to the order sheet a waitress uses to write down the dishes the customer wants in the real restaurant when the customer tries to order the dishes while sitting besides the table in the restaurant.
   The “online ordering sheet” is persistently presented on the right hand of the ordering screen on the customer's computer no matter how the customer will go back and forth from page to page, and from category to category, to review the menu items, and to select the items to be ordered. On the left hand side, the menu items changes every time the customer goes from one page to another to review the menu.
   Every time the customer chooses some items to order, the items of his/her choice and the number of items to be ordered will be firstly highlighted in the menu sheet and stay current and persistent in the menu sheet. It will not be changed even if the customer goes to different page or category for more orderings, it will stay highlighted without being refreshed. This allows the customer to go back and forth between pages to make his/her own choice without losing his/her previous choice for other items. When he/she updates the order sheet, the items he/she has chosen will then be copied over to the “online ordering sheet” with all the necessary information to make online ordering.
   Again, the “online ordering sheet” will stay persistent with all the items updated by the customer, and will not lose any information no matter how the customer will go back and forth between pages and categories. So the customer can always see what have been placed into the ordering sheet, how much they cost, and etc.
   When the customer finishes his/her selection, he/she can choose the service options, such as “take out” or “delivery”, and then select the time and addresses that are required for the service, and then update the “online ordering sheet”. The information will again be copied onto “online ordering sheet” and then stay persistently viewable at all time anywhere during the ordering process.
   Once the customer finishes all the selection and provides all the necessary information, he/she can start to submit the online order request. At this time, all the information inside the “online ordering sheet” will be presented to the customer again, with the options again to change anything to the selection, such as “deleting” any of the items ordered, or “modifying” any of the numbers of the items to be ordered. At the same time, the system allows for the customer to write additional notes in addition to the ordering to specify any special needs or requests from the customer for the online ordering, such as to make certain food “more” or “less” “spicy”, and etc.
   If everything is ok after the final review, then the customer can finally submit the online request to the corresponding business. Then the online request will be instantly sent to the corresponding business owner directly and automatically, through mobile phone instant message, fax transmission, email, Internet account, or sometimes, the network attached printers (pending on the owner's preference), all at the same time, simultaneously.
   The “online ordering sheet” is one of the most distinct features embedded and supported inside our unique and highly scalable system architecture and most innovative platform implementation, and is most flexible, persistent, versatile, convenient and intuitive to use for the end consumers.
15) Online order with coupon
   Coupon is something very special in people's daily life. It covers almost from anything that may touch people's life. It is an excellent way for merchants to attract potential consumers to try to use a new product, or try to attract the customers to keep coming back.
   Coupon is mostly distributed through massive distribution channel to the hands of consumers, either through flyers, coupon books, or nowadays though Internet web site. For restaurants, it is much more important to attract the loyal customers in the local community to come back regularly. Therefore it is very critical to be able to reach out to the customers with new coupons all the time. Mostly, the coupons are distributed through the traditional means as any other types of coupons.
   With the use of online ordering, more and more people like to use Internet to order food directly without the hassle to call the restaurant and get a busy signal or to wait on the phone for 5˜10 minutes, or to talk over the phone loudly to make sure the restaurant employee understands the customer's spoken English and know what the customer is asking for.
   Online order provides a lot of convenience for customers so they can even order the food when the restaurants are closed for the day. However, if the customer wants to use the coupon offered by the restaurant separately or in combination with the online order, normally the customer has to bring the hard copy of the coupon from the restaurant or print a copy from the Internet and then presents to the restaurant physically. This is still a traditional and very old style of using coupon, and is not convenient to the customer at all, while he/she is already using Internet to place online order to the restaurant.
   It is in this invention that a new way of using coupon is proposed and implemented in our web portal for the “online order with coupon” service. We design our system architecture in the fully integrated way so that coupon is now also part of orderable items inside the online order system. All the coupons are listed as separate orderable items, and each coupon can be ordered separately.
   When the requested coupon is clicked upon for online ordering, the content inside the coupon will be managed in the way that the customer can actually determine the price of the coupon (absolute price, or the relative discount, or discount with conditions against the regular order amount, and etc), and the content of the coupon.
   For example, the content of the coupon can be as simple as one statement as below: “offer discount up to 10% for order amount up to $30, and 20% for order amount up to $80.” In this case, the online order system has to check to see if the customer has already ordered some regular food into the “online ordering sheet”. If not, the coupon cannot be used. If the regular order has been selected, then the system will check to see the total amount of the regular order is in the range of the offered coupon. If it is within the valid range, the discount level will be applied to the regular order, and the total order price will be determined. And finally the online order with the intelligent information of the corresponding coupon will be sent to the restaurant instantly, so the business owner will know that the right coupon has been applied to the order and they will honor the “online order with coupon” without asking for the presentation of the hard copy of the coupon itself.
   Another example is when the content is quite complex, such as the following: “offer a family deal with three any types of large Pizza, each with 2 different toppings at customer choice for a total of $30 only, with three additional soft drinks of any kind free”. In this case, once the coupon is clicked upon and selected by the online ordering customers, the system will have to present the customers with all the available types of large Pizza asking the customers to choose three types of different large Pizza he/she likes first. For each of the large Pizza, the system shall then have to present the customer with all the available toppings he/she can choose from for the particular Pizza. The customer can only choose two toppings, not one, not three. In the end, the system will also present all the available soft drinks for the customer to choose three soft drinks from them.
   Once it is done, the “online order with coupon” will be combined with other regular online orders, all onto the “online ordering sheet” and then sent to the restaurant instantly.
   In summary, through the illustration of the above example, “Online order with coupon” as a feature has been disclosed and it is considered to be one of the most innovative features in our architecture design and system platform implementations. To the best of our knowledge, it has never been proposed and implemented and offered to the Internet customers so far.
16) Interactive Online catering
   One of the most tedious and time consuming tasks in restaurant business is the catering process. Each time a customer calls to ask for catering service, it will take a lot of time to interact with the customer to decide what exactly is required in order to support the catering events.
   Most of the time, the customer will even have to drop by the restaurant to sit down with the business owner to discuss in great details on how to organize the catering events. After that there will still be a lot of back and forth phone calls to make modifications and to make sure the catering menus.
   Nevertheless, the catering market is one of the largest markets in restaurant business and therefore normally the business owners are willing to put up a huge amount of personal time to see through all the details for any catering event.
   In order to address such a huge market and eliminate the tedious work, we have a very innovative and unique approach to solve this problem. We proposed a new architecture in our system design and have a platform implementations to support “online catering” feature.
   “Online catering” is a platform that allows the customer and the business owners to discuss and decide on the details of the catering events through the Internet. It is part of the integrated “online ordering” process, except now the ordering menu is not the regular food menu for online order. Rather it is the special catering menu that will be used as the initial starting point for the catering event discussion.
   The customer will review the available standard catering menu online, and select what is more suitable for the catering events, and then write some notes and send to the business owner. Normally, there will be a lot of additional request attached to the first online catering request. These additional requests will be received by the business owner instantly. He/she can decide if there is a need to modify the online catering menu, to add items, to change price, and etc, based on the input from the customer. Then the customer can review the online catering selections he/she has made so far, and do the necessary changes or modifications.
   This process can keep going anytime, anywhere, from any computer, by both the customer and the business owner. All the selections are made available through online process with a simple click of mouse. Both of them do not need to write down anything or calculate anything. The entire “online catering” process is interactive and can be consistently updated. In addition, more than two persons can be involved. For example, from customer side, anybody from the entire catering party can review the catering menu and the ordered food, while other people from the restaurant sides can also review the catering events, modify or prepare for the events using “online catering” information.
   In addition, all the catering events are stored in the central database, and both the customer and the business owner can check out all the catering events information anytime in the future. This type of information will become an invaluable asset to the customer or the business owner.
17) Online reservation with advanced order of dishes
   There are several online reservation sites in the market place, but none of them has used the wireless instant message to notify the customers or the business owners, which is one of our distinct and innovative features in our system design.
   However, to meet the ever increasing demand of the more advanced customers, there is an even better way to help the well organized customers to arrange for business dinners, celebration or wedding parties, anniversary events, family or friend get together.
   This is to allow for the advanced planning for the types of dishes to be served for the entire party or for the individual guest at the restaurant after the arrival of the guests. This can be achieved during the online reservation process, when the customer submits the online request indicating what type of party it will be and what will be the special requirement he/she would like to have for the party from the restaurant. At the same time, the customer shall be able to review the online order menu carefully, and decide on which dishes should be ordered in advance at the time of reservation. So the customer can make the reservation and at the same time make the order for the food to be served on the date of arrival. In this way, the customer will save a lot of valuable time by avoiding waiting in the restaurants for a large party, and also will make sure the restaurant has the right dishes for the party in case the restaurant runs out of the necessary food for some of the favorite dishes.
   In addition, our solution has also the unique feature to assign each menu item with a unique customer note, so that each dish or menu item can be associated with one special note or a special person's name. (Please note this is one of the very innovative solutions in our system which will be addressed in the next session of this patent application. It is so called “online ordering with individual note and label on each menu item” feature)
   This feature is particularly important when making online reservation with advanced online order. Each order can be assigned with one or more person's names, so that it will be very easy for the restaurant and the party organizer to manage the dishes and to make sure each guest gets what they want in advance without any confusion. Each guest can even go online any time prior to the arrival time to review the choice of his/her food and make his/her own selection and modification. Please note this feature is also one of the most innovative solutions in our system, which allows each of the party members to be able to login into the same online reservation or online ordering record and do the modification or selection on his/her part. This is so called “group online reservation or group online ordering” feature that will be addressed in the next few sessions as well.
   This “online reservation with advanced ordering” feature offers a great deal of convenience for online customers, and also for restaurant owners, who will have more and more loyal customers.
   So far, in the online service industry, no company has offered such service yet in the restaurant business. We are the first to propose such a business model and implement such a fully integrated online order and online reservation system.
   If offers our customers the most compelling advantage in using online reservation with advanced order capability.
18) Online order using menu supporting multiple languages
   Restaurant business is very different and unique compared with other businesses. First of all, there are all kinds of restaurants everywhere that serve different types of cuisines and foods. All of them serve the entire communities but each with very different and particular focuses to specific groups of population, and very often to specific ethic groups. Within those ethic groups, there will still be a large variation in education and income levels. Some of them can only read menus in their own ethic language, and some of them may prefer to use menus in their own mother languages regardless how fluent their English may be.
   When coming into restaurants, some food and dishes can only be best expressed or described in their native language in order to precisely convey the message to the ethic native speakers. That is why many restaurants actually prepare two different menus, one for English readers, and the other for the native language speaker. Some restaurants may combine these two menus together into one menu that contains both languages: English and the other native language.
   Because of this very reason, and also in order to address to the entire population, and to help the restaurants to attract more customers, an innovative solution has been first proposed and implemented in our online order and reservation system, which supports dual languages inside the online order menu simultaneously. One is English, and the other is the native language the restaurant may like to use to attract the specific ethic group in the community. For each of the restaurant, the native language can be chosen to be different based on the need from the restaurant.
   In this way, our solution and business model has addressed a very common and unique problem throughout the restaurant industry, which no company and no Internet service product has ever addressed so far. This is very unique in the way that only the menu portion supports two different languages so that both the English speaker and the native speaker can recognize the same dish but in a totally different sense of comprehension. This helps tremendously both the customers and the restaurant owner.
19) Online order using menu supporting individual note and label input for each dish
   For different restaurants, each dish might have a different flavor. For example, in Thai restaurant, many of the dishes can be customer made to suit the taste of the individuals. Some may like the dish to be very spicy, some may like it to be spicy, some may like it to be mild and some may like it to be non-spicy at all, such as for kids. Therefore there are a great deal of needs to be able to order each dish with different notes from the online menu so that the restaurant can understand the special needs or taste of each customer, and therefore can better serve their customers and retain the customers' loyalty.
   In addition, as mentioned above in the “online reservation with advanced order” feature, each dish can be assigned with a different people's name so that the restaurant would know who this dish will be for when the guests come to the restaurant.
   Or as will be discussed in the below session on the “group or corporate online reservation and online order” feature, each customer from the same group or corporation can order different food themselves, and each dish can be assigned with different customer names, so that when the food gets delivered to the group or the corporation, each dish will be assigned or associated with different person.
   Therefore, in order to address the real needs from customers and from the restaurants, a new feature in our architecture has been proposed and implemented to serve our customers better. This is the feature called “online order using menu supporting individual note and label input for each dish”. Each of the notes can be the name of the person this dish is for, or the way the dish should be made in order to suit to the customer's taste, or the combination of both, or even any other note the customer would like to add. For example, the customer can ask the restaurant to prepare certain dishes much earlier before the arrival of the group, or ask the restaurant to not to start to prepare this dish until after their arrival because the customer wants to have the hot taste of the dish when it is just cooked when he/she starts to sit down in the restaurant.
   No matter what the customer wants, the feature provides all the flexibility and convenience to the end consumers and the restaurant owners alike. So far, no company or no web site has ever proposed and implemented this. This is to our best knowledge the first of such implementation in the real online services.
20) Group or corporate online reservation and online order
   In the Internet age, more and more people are using Internet. All the employees within a corporation are using Internet. Most of people's family members and friends are also using Internet. For example, for all the high school or college students, many of them are using myspace.com and facebook.com to do the social networking.
   It is natural that when the a group of people from the same company want to get their lunch ordered, each likes to have their own choice of food, but would like all the food to be delivered at the same time to the same company location for a group lunch or dinner, or even business meetings.
   Or a group of friends like to have different food from the same restaurants delivered to the same address, which may be one of the person's home address, or one of the company addresses.
   Or the family members like to order the different food and get delivered to their parent's home at the same time so all of them can come together for a celebration party or Sunday home-coming dinner.
   They are many other occasions that a group of people would like to make online ordering from the same restaurant and get the food delivered to the same address at the same time. Basically, all the online order will be treated as one “group order” or one “corporate order”. The common part of this order is that everybody in the same group can login into the web site using the different name and password, but can identify themselves as one of the same group, and order different food for the same order number. This can be done by different people from the same group individually using their own user ID and password, or can be done by the group organizer or the corporate secretary, receptionist or administrative assistant on behave of all the individuals in the group to order different food for them individually, but get all the food delivered on the same order request.
   The group or the corporation can also establish long term relationship with the Internet service company who is providing the online order and reservation service, so that the corporate needs only to deal with the online Internet service company for the payment, while the Internet online service company will pay the restaurant accordingly. The closing of these payments may be on different terms. For example, the Internet service company may pay the restaurants instantly using their own credit cards, and then get paid by the corporation later on monthly or quarterly basis. Or the group or the corporation may simply pay the restaurant directly, and the Internet service company will not be involved with the payment between the end consumer and the business owner. There are different operation modes that form the foundation of a new set of Internet service business model. Regardless, the “group and corporate online order and reservation” system is a novel, unique, very handy and useful service for Internet age population.
21) Online order and reservation with periodic statistical analysis and billing
   One of the issues on online order and online reservation system is to keep tracking on the past orders and reservations that have been rightly fulfilled, and to keep tracking the activities of customers, and the statistics of the return customers vs. new customers, and etc.
   Our system has utilized a centralized database which allows both the end consumers and business owners to utilize the exact same database to extract all the information that is relevant to them only. Since all the detailed records have been kept so the customers or owners can login in to get all the information they need. The owner will have all the information for the past orders, and reservation, and can look into the information through various categories, such as the most ordered dishes, the average order amount, the most frequently ordering time, how often the coupon is used associated with the order, what types of coupons have been used most frequently, the customer contact information, locations, how many loyal or frequent return customers, how often the order is for pick up or for delivery. Similar information can be obtained to online reservation records, such as: average number of seats reserved, time of the reservation, time of the arrivals, types of customers, their contact and locations, and etc.
   Our system is unique in the way that we offer the customers and the business the ownership to their information and their data. We also offer them the analysis tool that will help them to surf through the data and draw their own conclusions to suit their own needs. Monthly or quarterly online bill statement is only one of the many ways to offer our customers the convenience and the power of our fully integrated comprehensive, automatic and yet interactive online order and online reservation system.
22) Online self loadable, editable, and orderable menu service
   In the past, most of the web site offers some menu services, such as by putting the restaurants' menu on the restaurants' web site, or on the Internet service aggregation web sites, so customer can go to the web sites to look for menu, check on the price, and see if certain restaurants have the dishes that they like.
   Most of these web sites only put either a pdf file on the website so customer can read and print, or they put html page on the web site so customer can surf around. There is normally not much to be done with the menu on the web sites. If it is a pdf file, then it is not easily searchable for the dishes inside the menu, not to say the price of each dish. If it is html file, then it is difficult for the owners to do anything about it if they like to change the menu themselves, or upload the new menu all together.
   Restaurant business is a very competitive business, and is changing on seasonable basis. For example, the owner has to make sure the dish he/she is serving is to the taste of the customers, otherwise he/she has to change it. Also, on all major holidays and periods with major events happening, the restaurants will most likely modify some of the dishes, add some specials and coupons, and adjust prices, and etc. It will be best if the restaurant owners can handle these changes themselves if they are provided with the easy way to update their own information on the menu. In order to do that, our system has started to handle the menu in a totally different and novel way compared with other web sites.
   Our business model is that with certain and proper business agreement with the restaurant owners, we will provide them with the total solution that allows them to do just that. We treat each menu as a self loadable file using XML technology. XML is a human readable computer language that is easy to understand and easy to track. Each menu will be directly input into a XML file that has dozen of tags to show the information in the menu, such as dish's native name in the native language, the dish's English name, the additional explanation note to each dish, the price, and any other information that is needed for that dish. Then this file will be automatically loaded into the database system utilizing our own special XML file loading capability so that it will be shown up in our system as the orderable menu for customer online order.
   At the same time, this menu become also fully searchable for each of the menu item parameters, such as the native name, the English name, the price, the note, and etc. We also develop our own search engine to search and compare items within the database. Therefore, the search engine can search for all the information related to the restaurant, and can also compare the different offerings from different restaurants, within the same regions or across the country. For example, the search engine can search for all the restaurants which offer a famous Chinese dish called “Peking Duck” and then automatically compare the offerings, and prices from each restaurant within certain areas. Our search engine can search items with many different categorized criteria in such it limits the unrelated information to be searched and displayed. In such our search should be much faster and very accurate to the need to the customers.
   Once the online menu is loaded into the system through the XML file, the business owner will then have the freedom to modify menu's contents on their own. Our system architecture is designed in such that we will provide an easily accessible and very intuitive web interface for the business owner only, to allow them to modify and change any of the menu items online.
   At the same time, since the menu is itemized and stored into central database, once the menu is modified and automatically loaded into the system by either the company, or the business owner, each item will be also automatically orderable through our online ordering system.
   Therefore, this system is the automatic, convenient and straightforward one that can be used by a large population of the restaurant owners themselves. This system is scalable and covers the broadest applications from the self editing and self loading of the menus, automatic loading into online ordering system, self update into the online system for end customers to use, to the ability to be fully searchable throughout the database detailed to each restaurant, location, its web site, each of its dish, its specialty, its price, and etc.
23) Online service aggregation web site with customized web portal hosting capability enabling online order and reservation service for each customer
   In the Internet age, millions of business has its own web site to market their business. But at the same time, there are still tens of millions of business which do not have the web site of their own. For example, in US, there are more than one million of restaurants, and most of them still do not have their own web sites.
   The reasons are many: some restaurant owners do not know anything about Internet, or do not know how to utilize Internet to market their business, or they do not want to spend money to build and maintain the web site. In addition, most of web sites, once designed and put into operation in the Internet, it is hard for the restaurant owner to go back to original designer or the company that has designed the web site, to update the menu and price information. This is mostly due to the high cost of maintaining and updating these restaurant web sites. Few companies can afford to keep doing so without charging a lot to the restaurant owner. A specially designed web site specifically for a restaurant can easily cost the owner several thousands and even more than ten thousands of dollars, which the owner may not like to pay up front, for a pure static web site without any other functionalities such as online ordering, online reservation, online coupon, and without the opportunity to update the web site with new information regularly.
   In order to address these issues, and give the owner the opportunities to update the menu items and prices on their own whenever they feel necessary, and also to cut down the cost of the upfront web site designs, we have come out with a very innovative approach.
   We design a restaurant web site template that is full with all the desired features such as online ordering, online reservation, online coupon, online status check, online reservation with advanced ordering, and online catering, and etc. For each restaurant, the web site will be automatically generated by the template, with the customized logos and other information. These special and restaurant specific information will be defined by a comprehensive XML file, which can be automatically loaded into the system to modify the common template and therefore generate a specific web site for the specific restaurant automatically.
   In addition, these XML common files are also built into the system through an owner accessible use interface on our web site. When the owner logins into the system and starts to modify the menu and the price, the modification and edit he/she makes will be automatically translated into the specific XML file associated with the restaurant. The XML file will then automatically loaded into the system to update the associated restaurant web site, including the automatic update on the online order menus and prices as well.
   With these functionalities and features, we have really achieved a truly automatic and interactive comprehensive system as an aggregation web portal that can automatically generate and host a large number of restaurant web sites, all with the complete sets of online service features full available to the restaurant owners so that they can choose any online services they like to be present on their web sites. This is a new approach to enable a cost effective and automatic process that can help many small and middle size restaurants to get online with all the powerful Internet service tools and options at their choice. This will significantly advance the use of Internet in the restaurant industry and help millions of users to enjoy the freedom and convenience of Internet and online services.

An advantage of the present invention is that it is a fully integrated and comprehensive online order and online reservation system that have many innovations and have incorporated a dozen of new and leading online service features, such as “online order sheet”, “online order with coupon”, “online reservation with advanced order”, “online order with dual languages”, “online order with individual notes”, “group and corporate online order”, “online service with periodic reporting”, “online catering”, “online hosting with automatic web site generation & update”, “online order menu automatic loading and self editing”, “online order with instant messaging notification”, “online order with automatic fax”, “online order with automatic Internet printing”, “online order and reservation with automatic online tracking system”, “online order and reservation automatic and interactive response system”, and etc.

These features are highly demanded both by the Internet users and by the business owners such as the restaurant owners. These features highlight the key benefits of Internet and mobile networks: freedom, on-the-go, convenient, instant, interactive, intuitive, traceable, searchable, statistically viable and useful, private, hassle free, intelligent, and most of all, free to the end consumers, and very low cost to the business owners.

These and other objects and advantages of the present invention will no doubt become obvious to those of ordinary skill in the art after having read the above and the following detailed description of the best mode which is described above.

The key part of our system is the centralized automatic online service platform utilizing Internet/computer/mobile device/fax/Internet attached printers to link the end consumers with business owners through the automatic process without any intermediary intervention of people.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the present invention.

What is claimed is:

1. A fully integrated online service platform, comprising of online order and online reservation systems that can operate either separately, or combined together, in order to suit to the different needs and taste of each of business owners in different industries.

2. Additionally or optionally, the online service platform of claim 1, wherein: said platform is designed in such to be an aggregation web portal to aggregate all the business together which is utilizing one of the unique features and online services provided by this web portal.

3. Additionally or optionally, the online service platform of claim 1, wherein: said platform is designed in such to be also portable and suitable for supporting the exactly the same services on the customized web site owned by the business owners as those on the aggregated online web portal.

4. Additionally or optionally, the online service platform of claim 1, wherein: said platform is designed in such to support the sending of online requests to the business owners instantly through the use of the instant notifications of Instant Messaging System (IMS) by mobile devices. That means, the business owners, the end consumers, and the Internet service platform operators will all be notified by the instant messages to their pre-selected mobile devices. Although the end consumers have the option to provide mobile phone number at their choice, the business owners and the platform operators can always get the instant notifications any time anywhere through multiple mobile devices, as long as the business owners are willing to utilize this service. This is not exclusive to other means of notifications. It is an option and the best options for business owners on the go.

5. Additionally or optionally, the online service platform of claim 1, wherein: said platform is designed in such to support the sending of online requests to the business floor managers instantly through the use of the instant notifications of automatic Internet based fax capability, utilizing the existing fax machine and fax line inside the business, such as at the restaurant front desk or its office. This option is again used either separately or combined with all other means of notifications. This option will allow the floor manager or people on duty to receive the hard copy instantly with all the online request details so that they can handle the online requests immediately after receiving it.

6. Additionally or optionally, the online service platform of claim 1, wherein: said platform is designed in such to support the sending of online requests to the business floor managers instantly through the use of the instant notifications of automatic printing by a network attached printer inside the business, normally at the front desk of the restaurant or at the manager's office. The printer can be the one attached to a computer connected to the Internet, or a standalone printer directly connected to the Internet through its own build in networking capability. Again this option is in addition to all other means and can be used either separately or combined with others. The printer can be a POS (point of sales) printer which can print out the online request in a label (using label printer) so that the business (in this case restaurant) can use the label directly as a traveling label for either the kitchen, the book keeping assistant, or the delivery agent, or the customer self pick up as well.

7. Additionally or optionally, the online service platform of claim 1, wherein: said platform is designed in such to support the sending of online requests to the business floor managers instantly through the use of the instant notifications of Internet and a comprehensive set of owner management interface for the business owners to respond to the internet requests easily and instantly. The manager or the owners, once signed up with the Internet service, shall have a login account with the Internet online service platform and the related web portal. After login in, they will be able to see all the online requests anytime, anywhere, and can then respond to the online request through a number of very convenient and easy to use functions to the end consumers instantly through the Internet. This notification is always present regardless what other means of notifications the business owners have chosen, in addition to this. Therefore, the business owners can always look into their online requests, for the present, pending, past, and total requests ever occurred and delivered to their business. The end consumers can also optionally choose to sign in before making the online requests so that he/she can also login in and check all the status online from anywhere at any time.

8. Additionally or optionally, the online service platform of claim 1, wherein: said platform is designed in such to support the sending of online requests to the business floor managers instantly through the use of the instant notifications of emails. The manager or the owners, once signed with the Internet service, shall receive the notification emails to the email addresses he/she designates, normally at the multiple business email addresses. Again, the email notification is always present and can be accessed anytime. Normally, this type of notification is in addition to other means of notifications, such as the use of Instant Messaging to mobile phones. All mobile phones can be set with different distinct ring music or tones to notify the business owners or floor managers that an online request has arrived and should be handled accordingly.

9. Additionally or optionally, the online service platform of claim 1, wherein: said platform is designed in such to support the interactive actions required to communicate between the end consumers and the business owners. Both of them can access all information through the Internet and can communicate with each other through simple to use interface to send requests to the business, to respond to the customers, to update the status, and to check on the status form the business. This interactive feature allows the use of Internet to achieve real time instant notifications to both sides without the hassle of calling back and forth, and without the difficulty to communicate sometimes due to the language barriers coupled with some dialects or strong accent from one party or both sides.

9. Additionally or optionally, the online service platform of claim 1, wherein: said platform is designed in such to support the unique “online ordering sheet” feature that mimics the real process inside a restaurant, when customers are ordering food at the spot inside the restaurant. This feature is like an online waitress waiting to write down what you like to order and you can also edit at any time during the online order process. It is a much more convenient feature to use compared with the so called “shopping cart” online. The “online ordering sheet” is persistent on the ordering page regardless how the customers are going back and forth to different pages to surf for the menus and search for the dishes, and is always visible all the time with all the information on the portion of the screen. It can also be hidden if the customer wishes to do so by just one click, and vice versa to expand it again to full view. It does not occupy the entire screen and all other menus items can still be fully visible and operational with the presence of “online ordering sheet” on portion of the screen.

10. Additionally or optionally, the online service platform of claim 1, wherein: said platform is designed in such to support the unique “online ordering with coupon” feature that offers the end consumers the benefits of coupon but without the hassle to obtain a hard copy of the coupon through different means and try to keep tracking of them. With online order coupled with coupon built in the process, the customer can enjoy the convenience brought by the Internet. They can use the coupon anytime and anywhere they want without going the extreme to try to find one hard copy at the time when they really need it. Very often, they just simply cannot find it even they have one in their drawer beforehand.
The “online ordering with coupon” also brings in benefits to the business owners to provide them with the flexibility to add, modify, and even delete the coupons at any time, while giving them a lot of savings to their marketing cost. The “online ordering with coupon” feature supports very complex algorithm inside the database, but offers simplicity to users.
It supports a variety of coupon types. For example, it supports a simple discount rate for all food ordered, or a specially discounted food if certain conditions in the regular food ordering process is satisfied. For example, if the regularly ordered food amount is beyond certain amount, some other foods will be either free or only half of the original price. The feature also supports customized coupon ordering, such in the case of Pizza ordering. The coupon can be a special type of Pizza with customer chosen compositions, such as different sizes, toppings, number of Pizzas, all of them can be customer selected when ordering the Pizza based on coupon.

11. Additionally or optionally, the online service platform of claim 1, wherein: said platform is designed in such to support the unique “group and corporate online ordering” feature that offers the group users and corporate users the much needed convenience and benefits that the regular individual users may not need.
Each group and corporate can order using one ordering sheet, under one group or corporate, to be delivered to the same address at the same time, or to be picked up by one person, but all the dishes are either ordered by each individual in the group or corporation, or the organizer on behave of them. However, each dish is labeled differently so that the business owner and also the organizer will know which dish is for whom and what will be the special treatment to each of the dish ordered. The group and the corporate can also sign up for the service that will be able to handle all the billings and tracking as well as the expense report for the group and corporation.

12. Additionally or optionally, the online service platform of claim 1, wherein: said platform is designed in such to support the “online ordering menu with dual languages support” feature that offers much better user experiences and facilitates the online order process, which addresses to a much larger population of end consumers and business owners. It addresses the distinct nature of restaurant industry or any other industries that have the same characteristics. Now each dish is provided with two languages, one is for English, and the other is for the native language used for the dish, which conveys the true taste of the dishes to the customers with the native language background.

13. Additionally or optionally, the online service platform of claim 1, wherein: said platform is designed in such to support the “online ordering menu with individual note and label” feature that offers much better user experiences and facilitates the online order process. With this flexibility, the customer can now specify for each dish what they would like to be processed in the restaurant, such as “more spicy” or “no pepper please”. This again tunes to the individual taste which is what the restaurant business is all about. It also allows the group or corporate ordering to label each dish for each of the designated end consumers, whether for group delivery or self pickup for the group.

14. Additionally or optionally, the online service platform of claim 1, wherein: said platform is designed in such to support the “online service with periodic statistical analysis and billing” feature that offers much better handling of the online service to the business owners. They can now have all the access to their own data and can produce all the summary report at their finger tips on periodic basis with all the tools and buttons provided by the online service. They can review their monthly or quarterly billing information, and the customer online request statistics.

15. Additionally or optionally, the online service platform of claim 1, wherein: said platform is designed in such to support the “online web site service with automatic menu loading and self editing” feature that offers much better handling of the online order service to the business owners. They can now have all the access to their own online menu and be able to modify them as they see the needs. An easy to access interface will provide them the ability to change and modify the online menu so that they can revise the online order menu regularly and still be able to allow the end consumer to continue to order the food. On their side, it is time saving, money saving and hassle free option they can enjoy.

16. Additionally or optionally, the online service platform of claim 1, wherein: said platform is designed in such to support the “online reservation” feature that offers very intuitive approach to the end users and also to the business owners. An update calendar will also be handy to the users, and the instant notifications to the owners make sure that the owners will be able to get the reservation anytime, anywhere, even when the business is closed for the day or for the time. So the consumers will not worry when to call and how to reach the business owner to confirm the reservation, since most of the reservation is made during off work time, and likely at night from home.
On the other hand, this feature allows the owner to respond to the customer by one or two simple clicks only. At the same time, the owner can respond to the customer reservation by cell phone in case he/she is out and the reservation is urgently to be confirmed. A full automatic response is made possible without owner's involvement as long as the owner has signed up for the service. The system will be able to search for the capacity in the restaurant and then decide automatically for the restaurant and then send back the response to the customer instantly.

17. Additionally or optionally, the online service platform of claim 1, wherein: said platform is designed in such to support the “online reservation with advanced ordering” feature that offers very innovative approach to the end users and also to the business owners. When corporate users or even individual users make the reservation ahead of time for some important business meetings or symbolic celebrations, sometimes the timing is critical and the purpose is more for business arrangement, or other reasons. People would like to have a very decent food, all ordered in advance, prepared by the restaurant right before the arrival of the guests, so there will be no waiting in getting the table, the services and as well as their favorite dishes.
The purpose of advanced reservation is to make sure to get the seats, but sometime, it is critical to also get the foods ready on time so there is not much of waiting, especially for the popular restaurants, where sometimes the waiting for food is very long at a good time or holiday season. This “advanced ordering” feature along with reservation addresses this issue and help the customer and business owner to work together to arrange for the upcoming events flawlessly.
The organizer can utilize the “group or corporate online ordering” feature and the “online ordering menu with individual notes and label” feature to place the advance food order for the upcoming party, when he/she makes the “online reservation” at the time. This is an excellent example how our fully integrated online order and online reservation system working together to meet the daily demand of real customers and to solve the problems facing the business owners.

18. Additionally or optionally, the online service platform of claim 1, wherein: said platform is designed in such to support the “online catering” feature that offers the much needed online service model to the restaurant industry. “Online catering” is a comprehensive platform that gives the customers and the business owners the ability to share the platform and communicate interactively with each other to prepare a catering event for the customer.
It allows the reservation, ordering, modification, and tracking to the catering request online by the customers. It also allows the business owners to respond to the online catering request, to modify the offerings and change the pricing, vary the pricing level, and add additional offerings or coupons/gifts items to the catering events, while negotiating the entire package on time. It allows the customers or business owners to have their internal reviews with all the available information anytime they need it. It eliminates many of the tedious and time consuming, error prone calculations and tracking to both sides. It saves the time to the customers for filing expense reports. It also allows the owners to track the business record and analyze the profit and cost accurately. It is an innovated approach to address the old business for the first time.

19. The online service platform is also applicable to other industries other than restaurants, Pizza stores, and all kinds of food order or delivery service industries. For example, it can be used for entertainment industry, barber shops, and etc., and any other businesses in need of integrated, interactive and instant online order or delivery services.
